(19) United States
(12) Patent Application Publication
(10) Pub. No.: US 2015/0336286 A1
(43) Pub. Date: Nov. 26, 2015

(54) Paper Cutting Tool

(71) Applicants: Royce A. Flynn, Sherwood, AR (US); Jeremy A. Flynn, Sherwood, AR (US)

(72) Inventors: Royce A. Flynn, Sherwood, AR (US); Jeremy A. Flynn, Sherwood, AR (US)

(21) Appl. No.: 14/713,296

(22) Filed: May 15, 2015

Related U.S. Application Data
(60) Provisional application No. 62/001,407, filed on May 21, 2014.

(51) Int. Cl. B26F 3/02; G01B 3/04

(52) U.S. Cl. CPC B26F 3/02; G01B 3/04

(57) ABSTRACT

A paper cutting tool is an apparatus that is used to align, measure, cut, and tear paper or other similar materials. The apparatus includes a handle which is gripped by the user during cutting. The handle also allows the user to easily maneuver the apparatus prior to, and after, cutting. A first rigid strip and a second rigid strip are connected to the handle at an angle. Both the first rigid strip and the second rigid strip include a proximal longitudinal edge and a distal longitudinal edge. The first rigid strip and the second rigid strip are connected to the handle at the proximal longitudinal edge. A cutting blade is connected to the distal longitudinal edge of the first rigid strip and is used to aid in the cutting process. The second rigid strip is used to stabilize the apparatus while the user is cutting a piece of paper.

The current application claims a priority to the U.S. Provisional Patent application Ser. No. 62/001,407 filed on May 21, 2014.

### FIELD OF THE INVENTION

The present invention relates generally to office accessories. More specifically, the present invention is a long cutting tool which can be used to align, measure, and cut or tear strips of paper and other similar materials.

### BACKGROUND OF THE INVENTION

Paper trimmers and scissors are two common tools which can be used to cut or trim pieces of paper or similar materials. Paper trimmers are utilize a rectangular base to align paper and a hinged blade to trim off a desired amount. This tool is very effective at cutting in a straight line, but is limited in portability and can only effectively trim paper which is smaller than the trimmer itself. Alternatively, scissors are highly portable and can be used for materials of any size, but can be more difficult to cut in a straight line.

Accordingly, there is a present need for a tool which can be used to accurately cut paper in a straight line and which is portable and can be used for materials of varying sizes. The present invention is a paper cutting tool which may be used to align, measure, and cut or tear strips of paper and other similar materials. The present invention is effective in cutting paper in straight lines and can be used on any hard, level surface. If the material being cut is wider than the present invention, the present invention may simply be repositioned along the length of the cut to continue cutting.

### BRIEF DESCRIPTION OF THE DRAWINGS

FIG. 1 is a front perspective view of the present invention.

FIG. 2 is a rear perspective view of the present invention.

FIG. 3 is a front view of the present invention.

FIG. 4 is a detailed front view of the present invention taken from the circle A in FIG. 3.

FIG. 5 is a front perspective view of the present invention, showing how the present invention is used to cut a roll of paper.

### DETAILED DESCRIPTION OF THE INVENTION

All illustrations of the drawings are for the purpose of describing selected versions of the present invention and are not intended to limit the scope of the present invention.

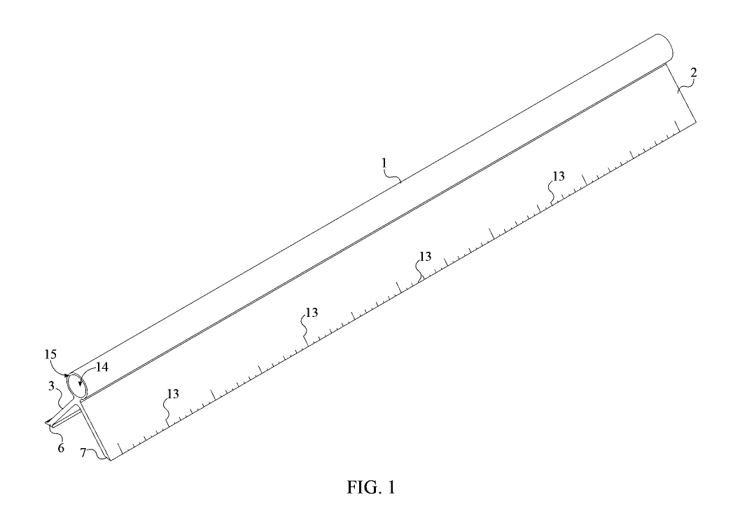

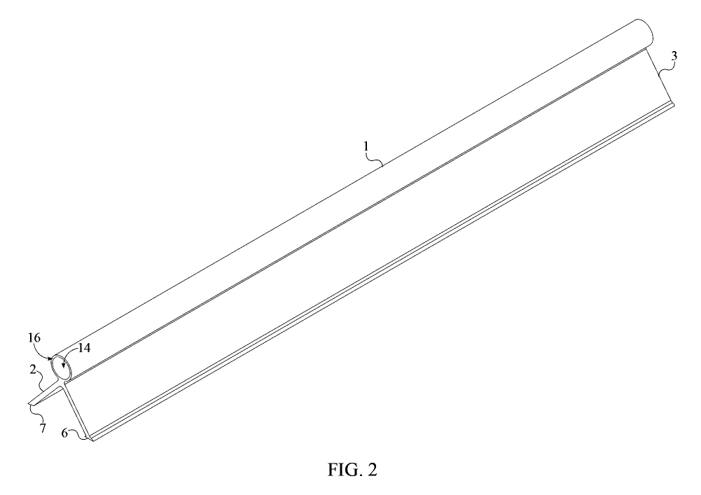

With reference to FIGS. 1-3, the present invention is a paper cutting tool which may be used to size and cut varying lengths of paper products, including: notepaper, wrapping paper, and construction paper. The present invention comprises a handle 1, a first rigid strip 2, a second rigid strip 3, and a cutting blade 7. It is preferred that the present invention is made from plastic; however, aluminum, steel, fiberglass, or any other material may be used. The first rigid strip 2 is used to press onto a piece of paper such that said paper may be cut or teared along the edge of the first rigid strip 2. The second rigid strip 3 is oriented at an angle 19 with the first rigid strip 2 and is used to stabilize the present invention on top of a piece of the material being cut. In the preferred embodiment of the present invention, the angle 19 between the first rigid strip 2 and the second rigid strip 3 is equal to 90 degrees. The first rigid strip 2 and the second rigid strip 3 each comprise a proximal longitudinal edge 4 and a distal longitudinal edge 5. The cutting blade 7 is connected adjacent and along the distal longitudinal edge 5 of the first rigid strip 2. The cutting blade 7 is used to aid in the cutting or tearing of a piece of paper. The proximal longitudinal edge 4 of the second rigid strip 3 is connected adjacent and along the proximal longitudinal edge 4 of the first rigid strip 2 in order to create a V-shaped cross section between the first rigid strip 2 and the second rigid strip 3. The handle 1 is used to grip the present invention and apply pressure to the paper being cut. The handle 1 is mounted adjacent and along the proximal longitudinal edge 4 of the first rigid strip 2 and the proximal longitudinal edge 4 of the second rigid strip 3. The handle 1 allows the user to position the present invention in an appropriate location and secure the present invention onto a piece of paper.

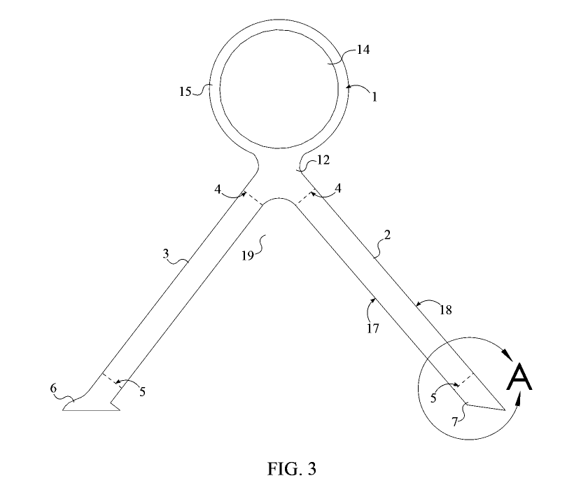

In reference to FIG. 3, the present invention further comprises a bridge 12. The bridge 12 is used to join the first rigid strip 2, the second rigid strip 3, and the handle 1 together. The handle 1 is positioned offset both the proximal longitudinal edge 4 of the first rigid strip 2 and the proximal longitudinal edge 4 of the second rigid strip 3. This spacing provides room for the user's fingers when the handle 1 is being gripped. The bridge 12 is connected in between the handle 1 and the proximal longitudinal edge 4 for both the first rigid strip 2 and the second rigid strip 3. The bridge 12 provides added strength to the connection between the first rigid strip 2, the second rigid strip 3, and the handle 1. This allows the user to press the present invention firmly against the material that is to be cut.

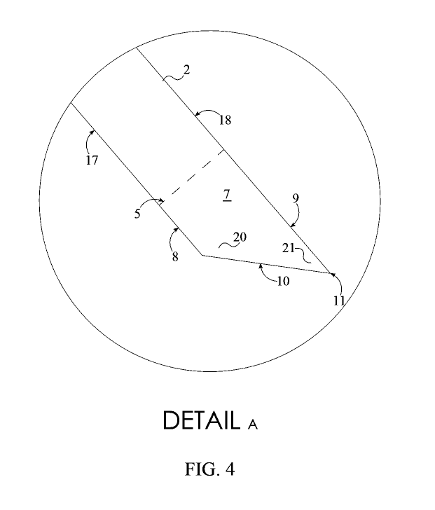

In reference to FIGS. 3-4, the cutting blade 7 comprises a proximal surface 8, a distal surface 9, a blade surface 10, and a blade edge 11. The proximal surface 8 is positioned coplanar to an inner surface 17 of the first rigid strip 2. The distal surface 9 is positioned coplanar to an outer surface 18 of the first rigid strip 2. The inner surface 17 and the outer surface 18 are positioned opposite each other about the first rigid strip 2. This configuration is designed such that the cutting blade 7 acts as an extension of the first rigid strip 2. The proximal surface 8 and the blade surface 10 intersect at an obtuse angle 20. The distal surface 9 and the blade surface 10 intersect at an acute angle 21. The angle in which the distal surface 9 meets the blade surface 10 determines the sharpness of the blade edge 11. The blade edge 11 is positioned at the intersection between the distal surface 9 and the blade surface 10. Therefore, a smaller angle between the distal surface 9 and the blade surface 10 corresponds with a sharper blade edge 11. The blade surface 10 may be straight, curved, jagged, or of any other shape. The blade edge 11 is positioned such that when the user applies pressure to the handle 1 of the present invention, the blade edge 11 will cut into the material being cut.

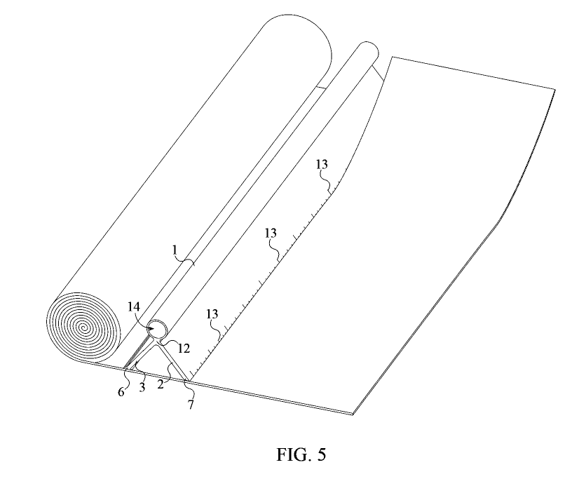

In reference to FIGS. 1 and 5, the present invention further comprises a plurality of measurement markings 13. The plurality of measurement markings 13 is used to accurately measure specific lengths of material to be cut. The plurality of measurement markings 13 is positioned on the distal surface 9, adjacent to the distal longitudinal edge 5. In the preferred embodiment, the plurality of measurement markings 13 is engraved onto the distal surface 9 of the cutting blade 7; however, the plurality of measurement markings 13 may be painted, embossed, or adhered onto the distal surface 9 of the cutting blade 7. In the preferred embodiment, the measurement markings display English and metric units on the distal surface 9 of the cutting blade 7. In addition to aiding the user in determining the length of the material to be cut, the plurality of measurement markings 13 may be used to help the user determine how far the material should be cut or teared.

In reference to FIGS. 1-3, the second rigid strip 3 further comprises a foot 6. The foot 6 is connected adjacent to the distal longitudinal edge 5 of the second rigid strip 3. The foot 6 is used to improve the stability of the present invention while the user is attempting to cut a piece of paper or some other material. The foot 6 also helps to prevent the present invention from flexing during the cutting operation. It is preferred that the foot 6 aligns flat against the material being cut. The present invention is able to stand by balancing on the foot 6 and the cutting blade 7. When the user is attempting to cut a strip of material, the foot 6 prevents the second rigid strip 3 from damaging said material. The present invention is able to pivot slightly about the foot 6 such that the cutting blade 7 is able to cut through the material.

The present invention further comprises a weight-reducing hole 14. The weight-reducing hole 14 cuts through the handle 1 to reduce the amount of material used to make the present invention and, consequently, reduce the overall weight of the invention. The handle 1 comprises a first end 15 and a second end 16. The first end 15 is positioned opposite to the second end 16 across the handle 1. The weight-reducing hole 14 traverses through the handle 1 from the first end 15 to the second end 16. By including the weight-reducing hole 14, the present invention is lighter and easier to maneuver. The weight-reducing hole 14 also helps to reduce the cost to manufacture the present invention.

In reference to FIG. 5, when using the present invention, a roll or sheet of paper, or other material is laid out on a level surface and an approximate length of material is pulled out. The present invention is placed on top of the material with the cutting blade 7 aligned with the point at which the material will be cut such that the foot 6 is positioned over excess material, instead of the desired piece of material. The present invention is then pressed firmly against the material. Depending on the material, the pressure applied by the user may be enough to cut through the material. If not, the user must pull an edge of the material upwards and towards the present invention in an even motion to complete the cut. If the width of the material is wider than the present invention, the present invention may be laterally repositioned after cutting a portion of the material.

In the preferred embodiment, the present invention is made by separately molding a first manufactured piece and a second manufactured which are then joined together. The first manufactured piece comprises a first half of the handle, a first half of the bridge, the first rigid strip 2, and the cutting blade 7. The second manufactured piece comprises a second half of the handle, a second half of the bridge, the second rigid strip 3 and the foot 6. The first manufactured piece and the second manufactured piece are joined along the handle 1 and the bridge 12. In alternative embodiments, the present invention may be entirely made from one piece of material.

Although the invention has been explained in relation to its preferred embodiment, it is to be understood that many other possible modifications and variations can be made without departing from the spirit and scope of the invention as hereinafter claimed.

What is claimed is:

1. A paper cutting tool comprises:
a handle;
a first rigid strip;
a second rigid strip;
a cutting blade;
the first rigid strip and the second rigid strip each comprises a proximal longitudinal edge and a distal longitudinal edge;
the cutting blade being connected adjacent and along the distal longitudinal edge of the first rigid strip;
the proximal longitudinal edge of the second rigid strip being connected adjacent and along the proximal longitudinal edge of the first rigid strip;
the second rigid strip being oriented at an angle with the first rigid strip; and
the handle being mounted adjacent and along both the proximal longitudinal edge of the first rigid strip and the proximal longitudinal edge of the second rigid strip.

2. The paper cutting tool as claimed in claim 1 comprises:
a bridge;
the handle being positioned offset both the proximal longitudinal edge of the first rigid strip and the proximal longitudinal edge of the second rigid strip; and
the bridge being connected in between the handle and the proximal longitudinal edge for both the first rigid strip and the second rigid strip.

3. The paper cutting tool as claimed in claim 1 comprises:
the cutting blade comprises a proximal surface, a distal surface, a blade surface, and a blade edge;
the proximal surface being positioned coplanar to an inner surface of the first rigid strip;
the distal surface being positioned coplanar to an outer surface of the first rigid strip;
the proximal surface and the blade surface intersecting at an obtuse angle;
the distal surface and the blade surface intersecting at an acute angle; and
the blade edge being positioned at the intersection between the distal surface and the blade surface.

4. The paper cutting tool as claimed in claim 3 comprises:
a plurality of measurement markings; and
the plurality of measurement markings being positioned on the distal surface, adjacent to the distal longitudinal edge.

5. The paper cutting tool as claimed in claim 1 comprises:
the second rigid strip further comprises a foot; and
the foot being connected adjacent to the distal longitudinal edge of the second rigid strip.

6. The paper cutting tool as claimed in claim 1 comprises:
a weight-reducing hole;
the handle comprises a first end and a second end;
the first end being positioned opposite to the second end across the handle; and
the weight-reducing hole traversing through the handle, from the first end to the second end.

7. A paper cutting tool comprises:
a handle;
a first rigid strip;
a second rigid strip;
a cutting blade;
a plurality of measurement markings;
the first rigid strip and the second rigid strip each comprises a proximal longitudinal edge and a distal longitudinal edge;
the cutting blade being connected adjacent and along the distal longitudinal edge of the first rigid strip;
the proximal longitudinal edge of the second rigid strip being connected adjacent and along the proximal longitudinal edge of the first rigid strip;
the second rigid strip being oriented at an angle with the first rigid strip;
the handle being mounted adjacent and along both the proximal longitudinal edge of the first rigid strip and the proximal longitudinal edge of the second rigid strip; and
the plurality of measurement markings being positioned on a distal surface of the cutting blade, adjacent to the distal longitudinal edge of the first rigid strip.

8. The paper cutting tool as claimed in claim 7 comprises:
a bridge;
the handle being positioned offset both the proximal longitudinal edge of the first rigid strip and the proximal longitudinal edge of the second rigid strip; and
the bridge being connected in between the handle and the proximal longitudinal edge for both the first rigid strip and the second rigid strip.

9. The paper cutting tool as claimed in claim 7 comprises:
the first rigid strip further comprises an outer surface and an inner surface;
the cutting blade comprises a proximal surface, a distal surface, a blade surface, and a blade edge;
the proximal surface being positioned coplanar to an inner surface of the first rigid strip;
the distal surface being positioned coplanar to an outer surface of the first rigid strip;
the proximal surface and the blade surface intersecting at an obtuse angle;
the distal surface and the blade surface intersecting at an acute angle; and
the blade edge being positioned at the intersection between the distal surface and the blade surface.

10. The paper cutting tool as claimed in claim 7 comprises:
the second rigid strip further comprises a foot; and
the foot being connected adjacent to the distal longitudinal edge of the second rigid strip.

11. The paper cutting tool as claimed in claim 7 comprises:
a weight-reducing hole;
the handle comprises a first end and a second end;
the first end being positioned opposite to the second end across the handle; and
the weight-reducing hole traversing through the handle, from the first end to the second end.

12. A paper cutting tool comprises:
a handle;
a first rigid strip;
a second rigid strip;
a cutting blade;
the first rigid strip and the second rigid strip each comprises a proximal longitudinal edge and a distal longitudinal edge;
the second rigid strip further comprises a foot;
the cutting blade being connected adjacent and along the distal longitudinal edge of the first rigid strip;
the proximal longitudinal edge of the second rigid strip being connected adjacent and along the proximal longitudinal edge of the first rigid strip;
the second rigid strip being oriented at an angle with the first rigid strip;
the handle being mounted adjacent and along both the proximal longitudinal edge of the first rigid strip and the proximal longitudinal edge of the second rigid strip; and
the foot being connected adjacent to the distal longitudinal edge of the second rigid strip.

13. The paper cutting tool as claimed in claim 12 comprises:
a bridge;
the handle being positioned offset both the proximal longitudinal edge of the first rigid strip and the proximal longitudinal edge of the second rigid strip; and
the bridge being connected in between the handle and the proximal longitudinal edge for both the first rigid strip and the second rigid strip.

14. The paper cutting tool as claimed in claim 12 comprises:
the first rigid strip further comprises an outer surface and an inner surface;
the cutting blade comprises a proximal surface, a distal surface, a blade surface, and a blade edge;
the proximal surface being positioned coplanar to an inner surface of the first rigid strip;
the distal surface being positioned coplanar to an outer surface of the first rigid strip;
the proximal surface and the blade surface intersecting at an obtuse angle;
the distal surface and the blade surface intersecting at an acute angle; and
the blade edge being positioned at the intersection between the distal surface and the blade surface.

15. The paper cutting tool as claimed in claim 12 comprises:
a plurality of measurement markings; and
the plurality of measurement markings being positioned on a distal surface of the cutting blade, adjacent to the distal longitudinal edge of the first rigid strip.

16. The paper cutting tool as claimed in claim 12 comprises:
a weight-reducing hole;
the handle comprises a first end and a second end;
the first end being positioned opposite to the second end across the handle; and
the weight-reducing hole traversing through the handle, from the first end to the second end.
